(19) United States
(12) Patent Application Publication
(10) Pub. No.: US 2023/0077386 A1
(43) Pub. Date: Mar. 16, 2023

(54) Attack Detector Architecture

(71) Applicant: Arm Limited, Cambridge (GB)

(72) Inventors: Shashank Guruprasad, Bangalore (IN); Roma Rudra, Bangalore (IN); Karthik Sankaranarayanan, Bangalore (IN); Mikael Yves Marie Rien, Bernin (FR)

(21) Appl. No.: 17/472,556

(22) Filed: Sep. 10, 2021

(51) Int. Cl. G06F 21/76; G06F 9/30

(52) U.S. Cl. CPC G06F 21/76; G06F 9/30101

(57) ABSTRACT

Various implementations described herein refer to a device having base registers that receive input signals, receive a reset signal and provide first output signals based on the input signals and the reset signal. The device may have shadow registers that correspond to the base registers, wherein the shadow registers receive inverted input signals, receive an inverted reset signal and provide second output signals based on the inverted input signals and the inverted reset signal. The device may have attack detector logic that receives the first output signals from the base registers, receives the second output signals from the shadow registers and generates an alarm signal based on the first output signals and the second output signals.

### BACKGROUND

This section is intended to provide information relevant to understanding various technologies described herein. As the section’s title implies, this is a discussion of related art that should in no way imply that it is prior art. Generally, related art may or may not be considered prior art. It should therefore be understood that any statement in this section should be read in this light, and not as any admission of prior art.

In conventional circuit designs, laser attacks on various parts of a circuit are a way of inducing faults in specific modules of a design. For instance, in some scenarios, attackers can likely disable security mechanisms by resetting specific parts of a design. Also, registers are easy targets to induce faults in a chip as the latches in the registers hold the state of the induced fault for a full clock cycle. Some detector circuits can detect attacks on various parts of a circuit to raise an alarm that is processed to start a preventive action, such as shutting down and resetting entire circuits. Also, an attack detector circuit can be implemented with scripts during implementation flow of the design and needs no or minimum hooks in register transfer logic (RTL). Unfortunately, conventional attack detection circuits are area inefficient and performance deficient, which increases costs associated with any attempt to implement malicious attack detection. Thus, there exists a need to improve efficiency of attack detector designs that enhances area and performance in modern circuitry.

### BRIEF DESCRIPTION OF THE DRAWINGS

Implementations of various memory layout schemes and techniques are described herein with reference to the accompanying drawings. It should be understood, however, that the accompanying drawings illustrate only various implementations described herein and are not meant to limit embodiments of various techniques described herein.

FIG. 1 illustrates a diagram of attack detector architecture with shadow registers in accordance with various implementations described herein.

FIG. 2 illustrates a diagram of alarm latch architecture in accordance with various implementations described herein.

FIG. 3 illustrates a diagram of attack detector architecture with near/far shadow registers in accordance with various implementations described herein.

FIG. 4 illustrates a diagram of attack detector architecture with extra shadow registers in accordance with various implementations described herein.

FIG. 5 illustrates a diagram of a method for providing attack detector architecture with shadow registers in accordance with various implementations described herein.

### DETAILED DESCRIPTION

Various implementations described herein refer to attack detector architecture with malicious attack detection schemes and techniques for supporting fault detector applications in reference to physical circuit designs. Also, various implementations described herein may provide shadow registers that are configured to detect fault inducing attacks, such as, e.g., optical attacks, on a physical circuit design, wherein an alarm signal may be generated when a malicious attack is detected. Various malicious attack detection schemes and techniques described herein may be configured to use various logic, such as, e.g., various logic gates and shadow registers that are arranged and configured to detect a malicious attack such that any impact on power, performance and area (PPA) is reduced, or at least lower to a minimum in physical circuit designs. In various implementations, duplicate/ shadow registers are used to detect fault inducing laser attacks on a chip, and an alarm may be generated when a circuit detects an induced bit-flip in a register. Various implementation based solutions may be used to cover an entire layout, acting as another layer of counter measure against such attacks.

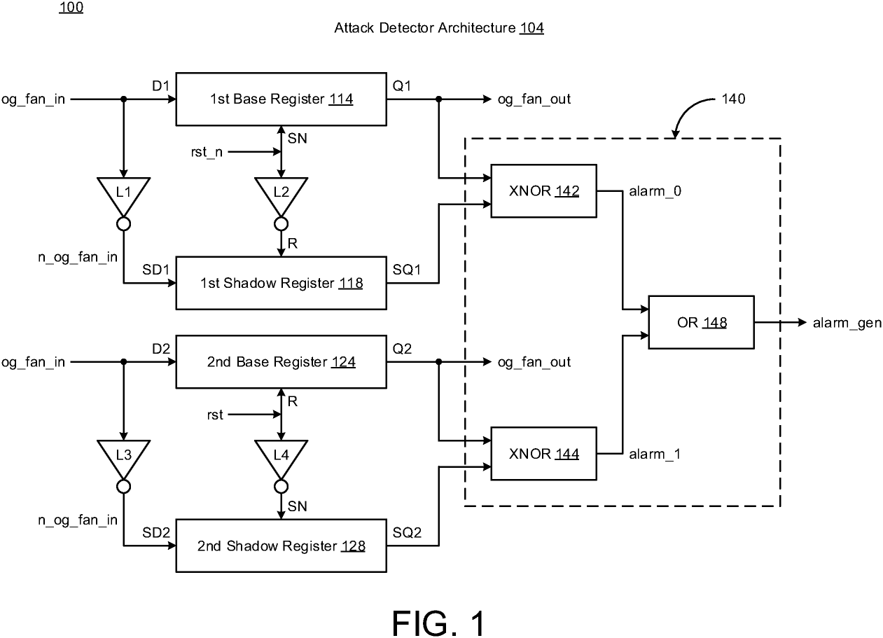

Various implementations of providing attack detector architecture with duplicate or shadow registers will be described herein with reference to FIGS. 1-5.

FIG. 1 illustrates a diagram 100 of attack detector architecture 104 with shadow registers 118, 128 in accordance with various implementations described herein.

In various implementations, the attack detector architecture may be implemented as a system or a device having various integrated circuit (IC) components that are arranged and coupled together as an assemblage or a combination of parts that provide for physical circuit designs and related structures. In some instances, a method of designing, providing, fabricating and manufacturing attack detector architecture as an integrated system or device may involve use of various IC circuits and components described herein so as to implement various related fabrication schemes and techniques associated therewith. Further, the attack detector architecture may be integrated with various computing circuitry and components on a single chip, and the attack detector architecture may be implemented and/or incorporated in various types of embedded systems for automotive, electronic, mobile, server and Internet-of-things (IoT) applications, including remote sensor nodes.

As shown in FIG. 1, the attack detector architecture 104 may be implemented as a logic based structure having base registers 114, 124, shadow registers 118, 128 and attack detector logic 140. In various scenarios, the base registers 114, 124, the shadow registers 118, 128 and the attack detector logic 140 may be arranged and configured to detect various malicious attacks, such as, e.g., optical attacks, laser attacks, etc.

The base registers 114, 124 may receive input signals (D1, D2), receive a reset signal (R, SN) and provide first output signals (Q1, Q2) based on the input signals (D1, D2) and the reset signal (R, SN). In some instances, the input signals (D1, D2) may refer to an original fan input signal (og_fan_in), the first output signals (Q1, Q2) may refer to an original fan output signal (og_fan_out), and the reset signal (R, SN) may refer to a reset signal (rst) or its complement reset signal (rst_n).

The shadow registers 118, 128 may refer to duplicate registers that correspond to the base registers 114, 124, respectively. The shadow registers 114, 124 may receive inverted input signals (SD1, SD2), receive an inverted reset signal (R, SN) and provide second output signals (SQ1, SQ2) based on the inverted input signals (SD1, SD2) and the inverted reset signal (R, SN). In some instances, the input signals (SD1, SD2) may refer to an inverted original fan input signal (n_og_fan_in), the second output signals (SQ1, SQ2) may refer to an inverted original fan output signal (n_og_fan_out), and the reset signal (R, SN) may refer to a reset signal (rst) or its complement reset signal (rst_n).

In some implementations, polarity of the input signals (D1, D2) and the inverted input signals (SD1, SD2) may be applied to subsequent pairs of base registers and shadow registers (e.g., 114/118 and 124/128). In reference to a first pair of base-shadow registers (114/118), the input signal (og_fan_in) may be applied to a data input (D1) of the first base register 114, and also, the input signal (og_fan_in) may be inverted with inverter (L1), and then the inverted input signal (n_ og_fan_in) may be applied to a data input (SD1) of the first shadow register 118. Also, in reference to a second pair of base-shadow registers (124/128), the input signal (og_fan_in) may be applied to a data input (D2) of the second base register 124, and also, the input signal (og_fan_in) may be inverted with inverter (L3), and then the inverted input signal (n_ og_fan_in) may be applied to a data input (SD2) of the second shadow register 128.

The attack detector logic 140 may receive the first output signals (Q1, Q2) from the base registers 114, 118, receive the second output signals (SQ1, SQ2) from the shadow registers 124/128 and generate an alarm signal (alarm_gen) based on the first output signals (Q1, Q2) and the second output signals (SQ1, SQ2). For instance, the attack detector logic 140 may have logic 142 that receives output signal (Q1) from base register 114, receives output signal (SQ1) from shadow register 124 and then generates intermediate alarm signal (alarm_0) based on output signals (Q1, SQ1). The attack detector logic 140 may have logic 144 that receives output signal (Q2) from base register 118, receives output signal (SQ2) from shadow register 128 and then generates intermediate alarm signal (alarm_1) based on output signals (Q2, SQ2). The attack detector logic 140 may have logic 148 that receives intermediate alarm signals (alarm_0, alarm_1) from logic 142, 144 and provides the alarm signal (alarm_gen) based on the intermediate alarm signals (alarm_0, alarm_1).

In some implementations, the attack detector logic 140 may be configured to sense a malicious attack based on the first output signals (D1, D2) and the second output signals (SQ1, SQ2), and also, the attack detector logic 140 may be configured to generate the alarm signal (alarm_gen) based on sensing the malicious attack. Also, the base registers 114, 118 and the shadow registers 124/128 may be arranged in corresponding pairs of base registers and shadow registers (e.g., 114/118 and 124/128). Therefore, in some instances, the attack detector logic 140 may have first logic 142, 144 that is configured to receive the first output signals (Q1, Q2) and the second output signals (SQ1, SQ2) from corresponding pairs of base registers and shadow registers (114/118 and 124/128), and the first logic 142, 144 may be configured to provide the intermediate alarm signals (alarm_0, alarm_1) based on the first output signals (Q1, Q2) and the second output signals (SQ1, SQ2). Moreover, the attack detector logic 140 may have second logic 148 that is configured to receive intermediate alarm signals (alarm_0, alarm_1) from the first logic 142, 144, and then, the second logic 148 may be configured to generate the alarm signal (alarm_gen) based on the intermediate alarm signals (alarm_0, alarm_1) from the first logic 142, 144.

In some implementations, polarity of the reset signal (rst) and the inverted reset signal (rst_n) may alternate for each subsequent pair of base registers and shadow registers (114/118 and 124/128). In reference to the first pair of base-shadow registers (114/118), the reset signal (rst_n) may be applied to a set input (SN) of the first base register 114, and also, the reset signal (rst_n) may be inverted with inverter (L2), and then the inverted reset signal (rst) may be applied to a reset input (R) of the first shadow register 118. Also, in reference to the second pair of base-shadow registers (124/128), the reset signal (rst) may be applied to a reset input (R) of the second base register 124, and also, the reset signal (rst) may be inverted with inverter (L4), and then the inverted reset signal (rst_n) may be applied to a set input (SN) of the second shadow register 128.

Also, in various implementations, logic 142 may refer to a logic gate, such as, e.g., an XNOR gate, and also, logic 144 may refer to another logic gate, such as, e.g., an another XNOR gate. Further, logic 148 may refer to another logic gate that is used as an output gate, such as, e.g., an OR gate. However, various other logic gate configurations may be used to achieve similar operational behavior, characteristics and/or results.

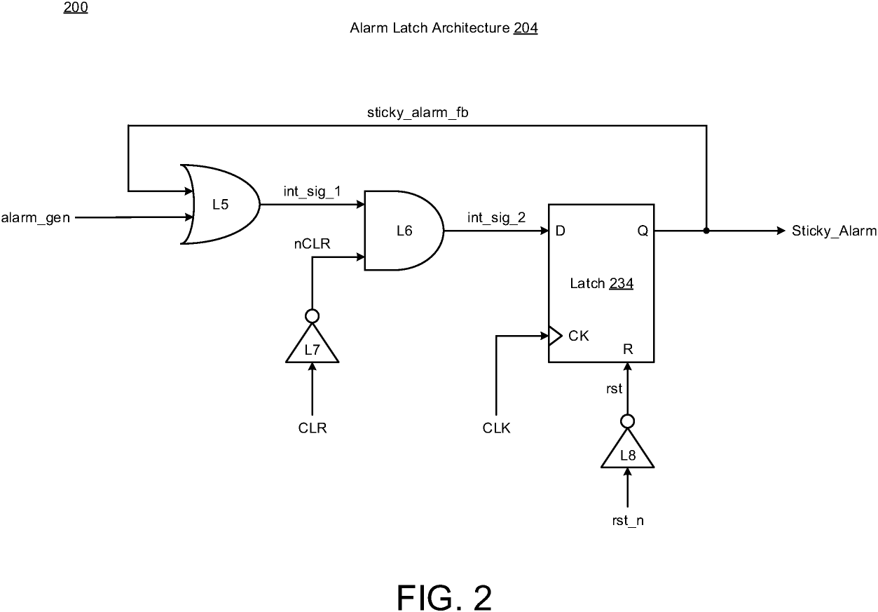

FIG. 2 illustrates a diagram 200 of alarm latch architecture 204 in accordance with various implementations described herein. In some cases, the alarm latch architecture 204 may be used in conjunction with the attack detector architecture 104 of FIG. 1.

In various implementations, the alarm latch architecture may be implemented as a system or a device having various integrated circuit (IC) components that are arranged and coupled together as an assemblage or a combination of parts that provide for physical circuit designs and related structures. In some instances, a method of designing, providing, fabricating and manufacturing alarm latch architecture as an integrated system or device may involve use of various IC circuits and components described herein so as to implement various related fabrication schemes and techniques associated therewith. Further, the alarm latch architecture may be integrated with various computing circuitry and components on a single chip, and the alarm latch architecture may be implemented and/or incorporated in various types of embedded systems for automotive, electronic, mobile, server and Internet-of-things (IoT) applications, including remote sensor nodes.

As shown in FIG. 2, the alarm latch architecture 204 may be implemented as a logic based structure having various logic (e.g., L5, L6) and a latch 234. In some instances, the alarm latch architecture 204 may be configured to receive the alarm signal (alarm_gen) from the attack detector logic 140 (in FIG. 1), latch the alarm signal (alarm_gen), and then provide a latched alarm signal (sticky_alarm). The alarm latch architecture 204 may include first logic (L5), second logic (L6) and the latch 234. The first logic (L5) may receive the alarm signal (alarm_gen) as input, receive the latched alarm signal (sticky_alarm) as feedback input (sticky_alarm_fb), and then provide a first intermediate signal (int_sign_1) as output. Also, the second logic (L6) may receive the first intermediate signal (int_sig_1) as input, receive a clear signal (nCLR) as input, and provide a second intermediate signal (int_sig_2) as output. Also, the latch 234 may receive the second intermediate signal (int_sign_2) as input, receive a clock signal (CLK) at a clock input (CK), receive the reset signal (rst_n) at a reset input (R) and provide latched alarm signal (sticky_alarm) based on the second intermediate signal (int_sig_2), the clock signal (CLK) and the reset signal (rst_n).

In some implementations, a clear signal (CLR) may be inverted with an inverter (L7), and then the inverted clear signal (nCLR) may be applied to an input of the second logic (L6). Also, the reset signal (rst_n) may be inverted with an inverter (L8) and then the inverted reset signal (rst) may be applied to the reset input (R) of the latch 234. Also, in some instances, the first logic (L5) may refer to a first logic gate, such as, e.g., an OR gate, and also, in some instances, the second logic (L6) may refer to a second logic gate, such as, e.g., an AND gate. However, various other logic gate configurations may be used to achieve similar operational behavior, characteristics and/or results.

In reference to detecting malicious attacks, particular registers in a design may be duplicated as shadow registers. As shown in FIG. 1, two register outputs are compared, and an alarm is raised if a discrepancy is detected. The alarm may be processed to start a preventive action (e.g., shutting down and/or resetting an entire circuit). Also, glitches in the comparison may be filtered by registering the final alarm output. The alarm detector circuitry may be built with implementation scripts, so no or minimal hooks are needed in the register-transfer logic (RTL), and the logical equivalence check (LEC) may run to ensure the duplicate register circuit does not affect the functionality of the design.

In the base configuration of shadow registers, the duplicated registers may have its D-input inverted, and this may ensure that sensitivities of original registers and duplicate registers to a laser are different, so that the risk of both the registers toggling is reduced, and this also assists with reducing EM emissions when the same bit is captured twice. Moreover, complimentary set/reset registers may be used, and this may prevent false alarms at start-up. In clock-gated designs, reset values may remain in the registers until the clock is enabled for that part of a design. Having the same reset values for the original and duplicate registers may raise false alarms before a clock propagates to the register.

In reference to the configurations shown in FIGS. 1-2, the duplicate register may be physically placed close to the original register, which may help reduce the wire lengths of the data and clock connections, so there’s a negligible difference on the power/performance of the design. In reference to the alarm latch circuitry, the comparison bits (outputs of XNOR) may be summed to generate a final alarm signal, and this alarm signal may be registered by the alarm latch circuit that converts the alarm pulse to a static high alarm. Setup/hold checks between the original/duplicate registers, and the alarm latch register may ensure that glitches are eliminated. The alarm latch circuit has the clear input to clear an alarm during testing.

In reference to selecting registers to duplicate, some techniques described herein may be used to duplicate security critical registers and/or location specific registers for full layout coverage. For full layout coverage, the design may be divided into grids, and the script may ensure that every box in the grid has at least one register duplicated. Also, the number of grid cells may be selected depending on the trade-off between the sensitivity needed and the power consumed. Also, one register may be selected from each cell of the grid through a script, wherein a mid-register is based on the coordinates. Also, corners of a floorplan may not be utilized, so there may be some locations where there are no registers.

In reference to a first round of placement, locations of registers is determined, and particular registers are selected for duplication. The shadow registers may then be inserted on a second run, and the locations fixed to the coordinates of the first run. This ensures that the full floorplan is covered and provides an additional layer of defense to detect laser attacks across the full physical layout. In reference to minimizing impact on PPA, the clock signals provided to the duplicate or shadow registers are connected to the corresponding clock signal of the original register. This ensures that shadow registers are active only when the original registers are active (clock ungated) and saves dynamic power on a clock tree. Also, the OR tree to sum the alarms is location aware, so nearby alarms are grouped to a single branch, which may minimize wire length. The base configuration may place the duplicate or shadow registers near or close to the original or base registers and inverted, which may assist with saving power and improve performance. Also, in some instances, setup timing to the D-input of the duplicate or shadow register should be met, and the idea of not having the additional buffer (but inverting the D-input signal) may improve the timing as an inverter generally takes lesser delay, and the extra net delay may be negligible.

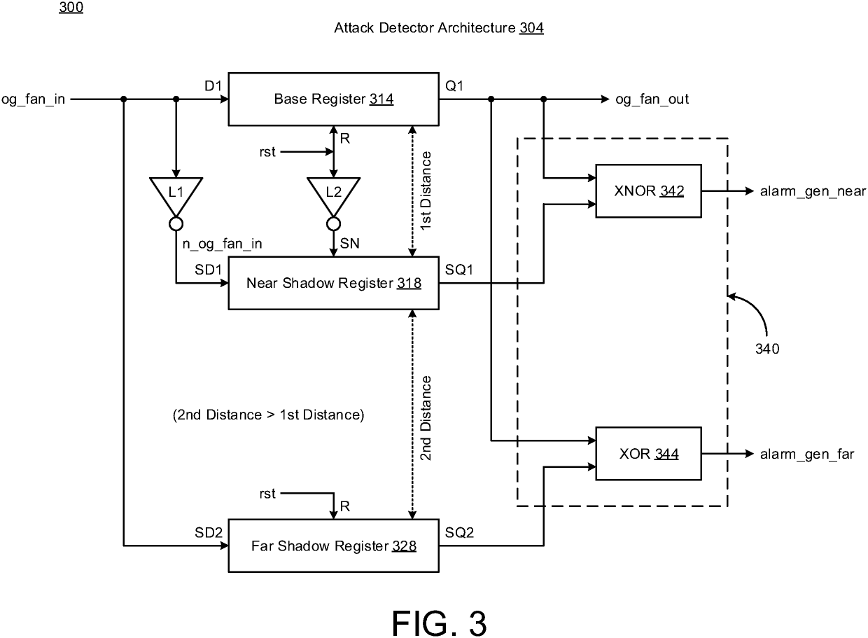

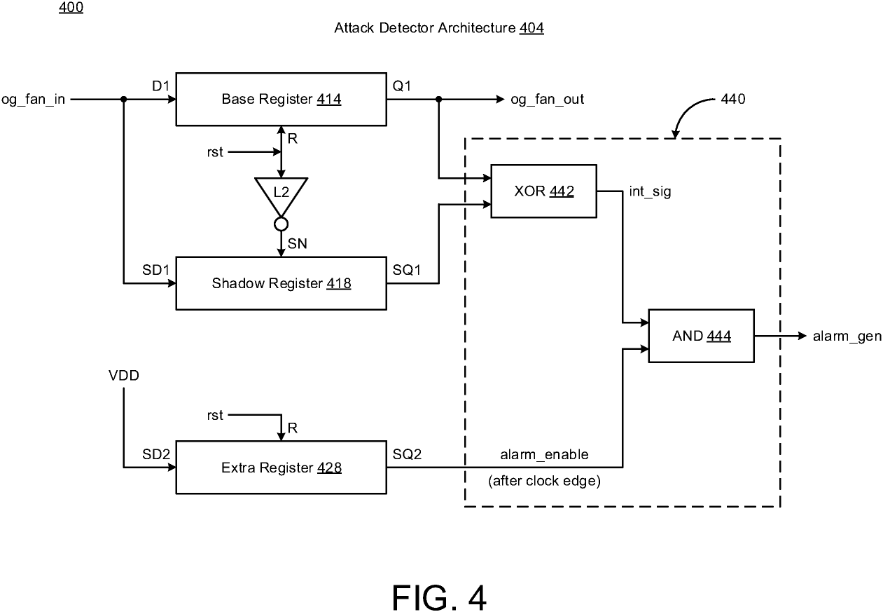

In reference to other configurations, when duplicate or shadow registers are placed close enough to the original or base registers, a laser attack may be used to toggle both the original and duplicate registers, which may go undetected. Thus, FIG. 3 provides another implementation that uses a subset of near/far registers with two duplicate or shadow registers for each original or base register, wherein one shadow register may be placed near or close to the base register, and wherein another shadow register may be placed far or further away from the base register. In some instances, comparing the near and far alarms in FIG. 3 during testing may provide an indication about the efficiency of placing the duplicate register closer to the base register and then inverting the D-input. Also, FIG. 4 provides another implementation that uses a subset of extra registers with duplicate or shadow registers for each original or base register, wherein the D-input is not inverted. For instance, when comparing alarms of the base configuration in FIG. 1, FIG. 3 provides the difference in sensitivity between the same input and an inverted input. In reference to FIG. 4, complimentary set/reset registers may be used to provide a comparison point for the base register configuration, and thus, an extra register may be used to ensure that there are no false alarms at reset.

FIG. 3 illustrates a diagram 300 of attack detector architecture 304 with near/far shadow registers 318, 328 in accordance with various implementations described herein.

In various implementations, the attack detector architecture may be implemented as a system or a device having various integrated circuit (IC) components that are arranged and coupled together as an assemblage or a combination of parts that provide for physical circuit designs and related structures. In some instances, a method of designing, providing, fabricating and manufacturing attack detector architecture as an integrated system or device may involve use of various IC circuits and components described herein so as to implement various related fabrication schemes and techniques associated therewith. Further, the attack detector architecture may be integrated with various computing circuitry and components on a single chip, and the attack detector architecture may be implemented and/or incorporated in various types of embedded systems for automotive, electronic, mobile, server and Internet-of-things (IoT) applications, including remote sensor nodes.

As shown in FIG. 3, the attack detector architecture 304 may be implemented as a logic based structure having base registers 314, near shadow registers 318, far shadow registers 328 and attack detector logic 340. In various scenarios, the base registers 314, the near/far shadow registers 318, 328 and the attack detector logic 340 may be configured to detect various malicious attacks, such as, e.g., optical attacks, laser attacks, etc.

In various implementations, the base register 314 may receive input signals (D1), receive a reset signal (rst) at a reset input (R), and provide first output signals (Q1) based on the input signals (D1) and the reset signal (rst). The near shadow register 318 may refer to a first shadow or duplicate register that corresponds to and is disposed near (or proximate to) the base register 318. The first shadow register 318 may receive inverted input signals (SD1), receive an inverted reset signal (rst_n) and provide second output signals (SQ1) based on the inverted input signals (SQ1) and the inverted reset signal (rst_n). Also, the far shadow register 328 may refer to a second shadow or duplicate register that corresponds to and is disposed away from the base register 314. The second shadow register 328 may receive the input signals (SD2), receive the reset signal (rst) and provide third output signals (SQ2) based on the input signals (SD2) and the reset signal (rst). Further, the input signals (SD2) may be similar to the input signal (D1).

In some implementations, polarity of the input signals (D1, SD2) and the inverted input signals (SD1) may be applied to subsequent sets of base registers 314 and near/far shadow registers (318, 328). In reference to the set of base-shadow registers (314/318/328), the input signal (og_fan_in) may be applied to a data input (D1) of the base register 314 and a data input (SD2) of the far shadow register 328, and also, the input signal (og_fan_in) may be inverted with inverter (L1), and the inverted input signal (n_og_fan_in) may be applied to a data input (SD1) of the near shadow register 318.

In various implementations, the near shadow registers 318 may be disposed near or close to their corresponding base registers 314, and the far shadow registers 328 may be disposed far or distant from their corresponding base registers 314. In some instances, the near shadow registers 318 may be disposed a first distance from their corresponding base registers 314, and the far shadow registers 328 may be disposed a second distance from their corresponding base registers 314 or their corresponding near shadow registers 318. In this instance, the second distance is greater than the first distance, wherein the far shadow registers 328 are disposed further away from their corresponding base registers 314 than their corresponding near shadow registers 318.

In reference to the set of base-shadow registers (314/318/328), the reset signal (rst) may be applied to a reset input (R) of the base register 314, and also, the reset signal (rst) may be inverted with inverter (L2), and then the inverted reset signal (rst_n) may be applied to a set input (SN) of the near shadow register 318. Also, in reference to the set of base-shadow registers (314/318/328), the reset signal (rst) may be applied to a reset input (R) of the far shadow register 328.

The attack detector logic 340 may receive the first output signals (Q1) from the base registers 314, receive the second output signals (SQ1) from the first (or near) shadow registers 318, receive the third output signals (SQ2) from the second (or far) shadow registers 328 and then generate one or more alarm signals (alarm_gen_near, alarm_gen_far) based on the first output signals (Q1), the second output signals (SQ1) and the third output signals (SQ2). The attack detector logic 340 may be configured to sense a malicious attack based on the output signals (Q1, SQ1, SQ2), and the attack detector logic 340 may be configured to then generate the one or more alarm signals (alarm_gen_near, alarm_gen_far) based on sensing the malicious attack.

The attack detector logic 340 may have first logic 342 that is configured to receive the first output signals (Q1) from the base registers 314, receive the second output signals (SQ1) from the first (or near) shadow registers 318 and then generate the first alarm signal as a near alarm signal (alarm_gen_near). The attack detector logic 340 may have second logic 344 that is configured to receive the first output signals (Q1) from the base registers 314, receive the third output signals (SQ2) from the second (or far) shadow registers 328 and then generate the second alarm signal as a far alarm signal (alarm_gen_far).

In various implementations, the first shadow registers 318 may be disposed near or close to their corresponding base registers 314, and the second shadow registers 328 may be disposed far or distant from their corresponding base registers 314. The one or more alarm signals (alarm_gen_near, alarm_gen_far) may refer to a first alarm signal or near alarm signal (alarm_gen_near) that may refer to a first type of malicious attack near or close to the base registers 314. The one or more alarm signals (alarm_gen_near, alarm_gen_far) may refer to a second alarm signal or far alarm signal (alarm_gen_far) that may refer to a second type of malicious attack far or distant from the base registers 314.

In various implementations, the first logic 342 may refer to a first logic gate, such as, e.g., an XNOR gate, and the second logic 344 may refer to a second logic gate, such as, e.g., an XOR gate. However, various other logic gate configurations may be used to achieve similar operational behavior, characteristics and/or results.

FIG. 4 illustrates a diagram 400 of attack detector architecture 404 having extra shadow registers 428 in accordance with various implementations described herein.

In various implementations, the attack detector architecture may be implemented as a system or a device having various integrated circuit (IC) components that are arranged and coupled together as an assemblage or a combination of parts that provide for physical circuit designs and related structures. In some instances, a method of designing, providing, fabricating and manufacturing attack detector architecture as an integrated system or device may involve use of various IC circuits and components described herein so as to implement various related fabrication schemes and techniques associated therewith. Further, the attack detector architecture may be integrated with various computing circuitry and components on a single chip, and the attack detector architecture may be implemented and/or incorporated in various types of embedded systems for automotive, electronic, mobile, server and Internet-of-things (IoT) applications, including remote sensor nodes.

As shown in FIG. 4, the attack detector architecture 404 may be implemented as a logic based structure having base registers 414, shadow registers 418, the extra shadow registers 428 and attack detector logic 440. In various scenarios, the base registers 414, the shadow registers 418, 428 and the attack detector logic 440 may be configured to detect various malicious attacks, such as, e.g., optical attacks, laser attacks, etc.

In various implementations, the base register 414 may receive input signals (D1), receive a reset signal (rst) at a reset input (R), and provide first output signals (Q1) based on the input signals (D1) and the reset signal (rst). The shadow register 418 may refer to a first shadow or duplicate register that corresponds to the base register 418. The first shadow register 418 may receive the input signals (D1/SD1), receive an inverted reset signal (rst_n) at a set input (SN) and then provide second output signals (SQ1) based on the input signals (D1/SQ1) and the inverted reset signal (rst_n). Also, the extra shadow register 428 may refer to a second shadow or duplicate register that corresponds to the base register 414. Also, the extra shadow register 428 may receive a source voltage input signal (VDD), receive the reset signal (rst) at a reset input (R) and then provide third output signals (SQ2) based on the source voltage input signal (VDD) and the reset signal (rst). Also, the input signals (SD1) may be similar to the input signal (D1).

In some implementations, the input signals (D1, SD1) and the source voltage input signal (VDD) may be applied to subsequent sets of base registers 414 and shadow registers (418, 428). In reference to the set of base-shadow registers (414/418/428), the input signal (og_fan_in) may be applied to the data input (D1) of the base register 414 and the data input (SD1) of the shadow register 418, and also, the input signal (VDD) may be applied to a data input (SD2) of the extra shadow register 428.

In reference to the set of base-shadow registers (414/418/428), the reset signal (rst) may be applied to a reset input (R) of the base register 414, and also, the reset signal (rst) may be inverted with inverter (L2), and then the inverted reset signal (rst_n) may be applied to a set input (SN) of the shadow register 418. Also, in reference to the set of base-shadow registers (414/418/428), the reset signal (rst) may be applied to a reset input (R) of the extra shadow register 428.

The attack detector logic 440 may receive the first output signals (Q1) from the base registers 414, receive the second output signals (SQ1) from the shadow registers 418, receive the third output signals (SQ2) from the extra shadow registers 428 and then generate the alarm signal (alarm_gen) based on output signals (Q1, SQ1, SQ2). The attack detector logic 440 may be configured to sense a malicious attack based on the output signals (Q1, SQ1, SQ2), and the attack detector logic 440 may be configured to then generate the alarm signals (alarm_gen) based on sensing the malicious attack.

The attack detector logic 440 may have first logic 442 that is configured to receive the first output signals (Q1) from the base registers 414, receive the second output signals (SQ1) from the shadow registers 418 and generate an intermediate alarm signal (int_sig) based on the output signals (Q1, SQ1). The attack detector logic 440 may have second logic 444 that is configured to receive the intermediate alarm signal (int_sig) from the first logic 442, receive the third output signals (SQ2) from the extra shadow registers 428 and generate an alarm enable signal (alarm_enable), e.g., after the clock edge is triggered.

In various implementations, the first logic 442 may refer to a first logic gate, such as, e.g., an XOR gate, and the second logic 444 may refer to a second logic gate, such as, e.g., an AND gate. However, various other logic gate configurations may be used to achieve similar operational behavior, characteristics and/or results.

In some implementations, the attack detector architecture 404 may be configured to utilize the alarm latch architecture 204 by generating and then providing the alarm signal (alarm_gen) to logic (L5) of the alarm latch architecture 204. As described herein above in reference to FIG. 2, the alarm latch architecture 204 may be configured to receive the alarm signal (alarm_gen) from the attack detector logic 440, latch the alarm signal (alarm_gen), and then provide a latched alarm signal (sticky_alarm) as output.

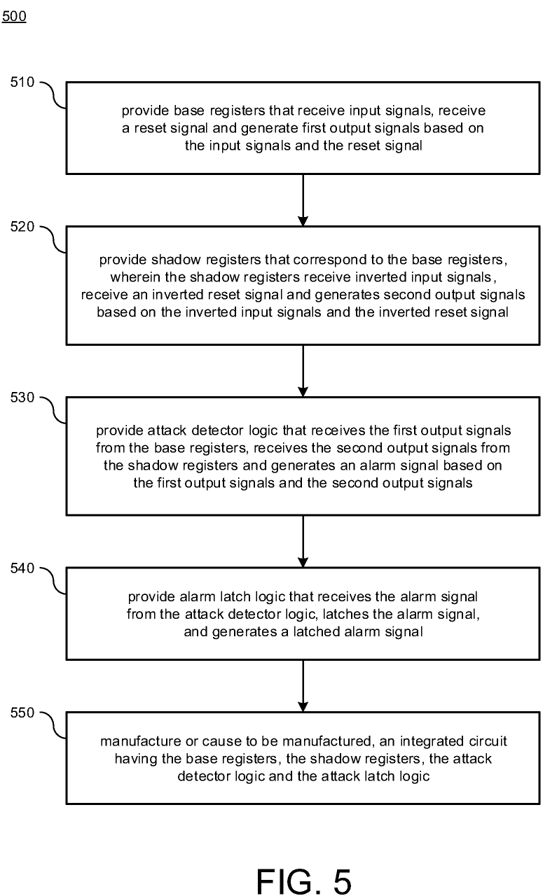

FIG. 5 illustrates a process diagram of a method 500 for providing attack detector architecture in accordance with various implementations described herein. Also, in various instances, method 500 may be used for detecting malicious attacks.

It should be understood that even though method 500 indicates a particular order of operation execution, in some cases, various portions of operations may be executed in a different order, and on different systems. In other cases, additional operations and/or steps may be added to and/or omitted from method 500. Also, method 500 may be implemented in hardware. For instance, if implemented in hardware, method 500 may be implemented with various components and/or circuitry, as described herein above in FIGS. 1-4.

As described in reference to FIG. 5, the method 500 may be used for fabricating and/or manufacturing, or causing to be fabricated and/or manufactured, an integrated circuit (IC) that implements various schemes and techniques in physical design as described herein so as to thereby provide for attack detector architecture using various devices, components and/or circuitry as described herein.

At block 510, method 500 may provide base registers that receive input signals, receive a reset signal and provide first output signals based on the input signals and the reset signal. At block 520, method 500 may provide shadow registers that correspond to the base registers, wherein the shadow registers receive inverted input signals, receive an inverted reset signal and provide second output signals based on the inverted input signals and the inverted reset signal. Also, at block 530, method 500 may provide attack detector logic that receives the first output signals from the base registers, receives the second output signals from the shadow registers and generates an alarm signal based on the first output signals and the second output signals. At block 540, method 500 may provide alarm latch logic that receives the alarm signal from the attack detector logic, latches the alarm signal, and then provides a latched alarm signal. At block 550, method 500 may manufacture, or cause to be manufactured, an integrated circuit having one or more of the base registers, the shadow registers, the attack detector and the attack latch logic.

In various implementations, the attack detector logic may be configured to sense a malicious attack based on the first output signals and the second output signals, and also, the attack detector logic may be configured to generate the alarm signal based on sensing the malicious attack. Also, the base registers and the shadow registers may be arranged in corresponding pairs of base registers and shadow registers. Also, polarity of the reset signal and the inverted reset signal alternate for each subsequent pair of base registers and shadow registers. Also, the attack detector logic may have first logic that is configured to receive the first output signals and the second output signals from the corresponding pairs of base registers and shadow registers, and the first logic may be configured to provide intermediate alarm signals based on the first output signals and the second output signals. Further, the attack detector logic may have second logic that is configured to receive the intermediate alarm signals from the first logic, and also, the second logic may be configured to generate an alarm signal based on the intermediate alarm signals from the first logic.

In various implementations, the alarm latch logic may be configured to receive the alarm signal from the attack detector logic, latch the alarm signal using a latch (e.g., a D flip-flop), and then provide the latched alarm signal. The alarm latch logic may include first logic that receives the alarm signal as input, receives the latched alarm signal as feedback input, and provides a first intermediate signal as output. The alarm latch logic may include second logic that receives the first intermediate signal as input, receives a clear signal as input, and provides a second intermediate signal as output. Also, the alarm latch logic may include the latch (e.g., a D flip-flop) that receives the second intermediate signal as input, receives a clock signal, receives the reset signal and provides the latched alarm signal based on the second intermediate signal, the clock signal and the reset signal.

It should be intended that the subject matter of the claims not be limited to various implementations and/or illustrations provided herein, but should include any modified forms of those implementations including portions of implementations and combinations of various elements in reference to different implementations in accordance with the claims. It should also be appreciated that in development of any such implementation, as in any engineering or design project, numerous implementation-specific decisions should be made to achieve developers' specific goals, such as, e.g., compliance with system-related constraints and/or business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Described herein are various implementations of a device with base registers that receive input signals, receive a reset signal and provide first output signals based on the input signals and the reset signal. The device may have shadow registers that correspond to the base registers, wherein the shadow registers receive inverted input signals, receive an inverted reset signal and provide second output signals based on the inverted input signals and the inverted reset signal. The device may have attack detector logic that receives the first output signals from the base registers, receives the second output signals from the shadow registers and generates an alarm signal based on the first output signals and the second output signals.

Described herein are various implementations of a device with base registers that receive input signals, receive a reset signal and provide first output signals based on the input signals and the reset signal. The device may have first shadow registers that correspond to the base registers, wherein the first shadow registers receive inverted input signals, receive an inverted reset signal and provide second output signals based on the inverted input signals and the inverted reset signal. The device may have second shadow registers that correspond to the base registers, wherein the second shadow registers receive the input signals, receive the reset signal and provide third output signals based on the input signals and the reset signal. The device may have attack detector logic that receives the first output signals from the base registers, receives the second output signals from the first shadow registers, receives the third output signals from the second shadow registers and generates one or more alarm signals based on the first output signals, the second output signals and the third output signals.

Described herein are various implementations of a device with base registers that receive input signals, receive a reset signal and provide first output signals based on the input signals and the reset signal. The device may have first shadow registers that correspond to the base registers, wherein the first shadow registers receive the input signals, receive an inverted reset signal and provide second output signals based on the input signals and the inverted reset signal. The device may have second shadow registers that correspond to the base registers, wherein the second shadow registers receive a source voltage input signal, receive the reset signal and provide third output signals based on the source voltage input signal and the reset signal. The device may have attack detector logic that receives the first output signals from the base registers, receives the second output signals from the first shadow registers, receives the third output signals from the second shadow registers and generates an alarm signal based on the first output signals, the second output signals and the third output signals.

Reference has been made in detail to various implementations, examples of which are illustrated in accompanying drawings and figures. In the following detailed description, numerous specific details are set forth to provide a thorough understanding of the disclosure provided herein. However, the disclosure provided herein may be practiced without these specific details. In various implementations, well-known methods, procedures, components, circuits and networks have not been described in detail so as not to unnecessarily obscure details of the embodiments.

It should also be understood that, although various terms first, second, etc. may be used herein to describe various elements, these elements should not be limited by these terms. These terms are only used to distinguish one element from another. For instance, a first element could be termed a second element, and, similarly, a second element could be termed a first element. Also, the first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and various other similar terms that indicate relative positions above or below a given point or element may be used in connection with various implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, specific features and/or acts described above are disclosed as example forms of implementing the claims.

What is claimed is:

1. A device comprising:
base registers that receive input signals, receive a reset signal and provide first output signals based on the input signals and the reset signal;
shadow registers that correspond to the base registers, wherein the shadow registers receive inverted input signals, receive an inverted reset signal and provide second output signals based on the inverted input signals and the inverted reset signal; and
attack detector logic that receives the first output signals from the base registers, receives the second output signals from the shadow registers and generates an alarm signal based on the first output signals and the second output signals.

2. The device of claim 1, wherein:
the attack detector logic is configured to sense a malicious attack based on the first output signals and the second output signals, and
the attack detector logic is configured to generate the alarm signal based on sensing the malicious attack.

3. The device of claim 1, wherein:
the base registers and the shadow registers are arranged in corresponding pairs of base registers and shadow registers.

4. The device of claim 3, wherein:
polarity of the reset signal and the inverted reset signal alternate for each subsequent pair of base registers and shadow registers.

5. The device of claim 3, wherein:
the attack detector logic includes first logic that is configured to receive the first output signals and the second output signals from the corresponding pairs of base registers and shadow registers, and
the first logic is configured to provide intermediate alarm signals based on the first output signals and the second output signals.

6. The device of claim 5, wherein:
the attack detector logic includes second logic that is configured to receive the intermediate alarm signals from the first logic, and
the second logic is configured to generate an alarm signal based on the intermediate alarm signals from the first logic.

7. The device of claim 1, further comprising:
alarm latch logic that receives the alarm signal from the attack detector logic, latches the alarm signal, and provides a latched alarm signal.

8. The device of claim 7, wherein:
the alarm latch logic includes first logic that receives the alarm signal as input, receives the latched alarm signal as feedback input, and provides a first intermediate signal as output,
the alarm latch logic includes second logic that receives the first intermediate signal as input, receives a clear signal as input, and provides a second intermediate signal as output, and
the alarm latch logic includes a latch that receives the second intermediate signal as input, receives a clock signal, receives the reset signal and provides the latched alarm signal based on the second intermediate signal, the clock signal and the reset signal.

9. A device comprising:
base registers that receive input signals, receive a reset signal and provide first output signals based on the input signals and the reset signal;
first shadow registers that correspond to the base registers, wherein the first shadow registers receive inverted input signals, receive an inverted reset signal and provide second output signals based on the inverted input signals and the inverted reset signal;
second shadow registers that correspond to the base registers, wherein the second shadow registers receive the input signals, receive the reset signal and provide third output signals based on the input signals and the reset signal; and
attack detector logic that receives the first output signals from the base registers, receives the second output signals from the first shadow registers, receives the third output signals from the second shadow registers and generates one or more alarm signals based on the first output signals, the second output signals and the third output signals.

10. The device of claim 9, wherein:
the attack detector logic is configured to sense a malicious attack based on the first output signals, the second output signals and the third output signals, and
the attack detector logic is configured to generate the one or more alarm signals based on sensing the malicious attack.

11. The device of claim 9, wherein:
the base registers, the first shadow registers and the second shadow registers are arranged in corresponding sets of base registers, first shadow registers and second shadow registers.

12. The device of claim 9, wherein:
the first shadow registers are disposed near or close to their corresponding base registers, and
the second shadow registers are disposed far or distant from their corresponding base registers.

13. The device of claim 9, wherein:
the one or more alarm signals include a first alarm signal that refers to a first type of malicious attack near or close to the base registers, and
the one or more alarm signals include a second alarm signal that refers to a second type of malicious attack far or distant from the base registers.

14. The device of claim 13, wherein:
the attack detector logic includes first logic that is configured to receive the first output signals from the base registers, receive the second output signals from the first shadow registers and generate the first alarm signal, and
the attack detector logic includes second logic that is configured to receive the first output signals from the base registers, receive the third output signals from the second shadow registers and generate the second alarm signal.

15. A device comprising:
base registers that receive input signals, receive a reset signal and provide first output signals based on the input signals and the reset signal;
first shadow registers that correspond to the base registers, wherein the first shadow registers receive the input signals, receive an inverted reset signal and provide second output signals based on the input signals and the inverted reset signal;
second shadow registers that correspond to the base registers, wherein the second shadow registers receive a source voltage input signal, receive the reset signal and provide third output signals based on the source voltage input signal and the reset signal; and
attack detector logic that receives the first output signals from the base registers, receives the second output signals from the first shadow registers, receives the third output signals from the second shadow registers and generates an alarm signal based on the first output signals, the second output signals and the third output signals.

16. The device of claim 15, wherein:
the attack detector logic is configured to sense a malicious attack based on the first output signals, the second output signals and the third output signals, and
the attack detector logic is configured to generate the alarm signal based on sensing the malicious attack.

17. The device of claim 15, wherein:
the base registers, the first shadow registers and the second shadow registers are arranged in corresponding sets of base registers, first shadow registers and second shadow registers.

18. The device of claim 17, wherein:
the attack detector logic includes first logic that is configured to receive the first output signals and the second output signals from the corresponding sets of base registers and first shadow registers, and
the first logic is configured to provide intermediate alarm signals based on the first output signals and the second output signals.

19. The device of claim 18, wherein:
the attack detector logic has second logic that is configured to receive the intermediate alarm signals from the first logic and receive the third output signals from the second shadow registers, and
the second logic is configured to generate an alarm signal based on the intermediate alarm signals from the first logic and the third output signals from the second shadow registers.

20. The device of claim 15, further comprising:
alarm latch logic that receives the alarm signal from the attack detector logic, latches the alarm signal, and provides a latched alarm signal.
